(19) United States
(12) Patent Application Publication
(10) Pub. No.: US 2020/0154925 A1
(43) Pub. Date: May 21, 2020

(54) TWO-IN-ONE CURTAIN AND ROLLER BLIND SUPPORT FRAME

(71) Applicant: ARLINEA INDUSTRIES CO., Taoyuan City (TW)

(72) Inventor: Yu-Heng YU, Taoyuan City (TW)

(21) Appl. No.: 16/600,546

(22) Filed: Oct. 13, 2019

(30) Foreign Application Priority Data
Nov. 20, 2018 (TW) 107215759

(51) Int. Cl. A47H 1/13; A47H 1/06; E06B 9/42

(52) U.S. Cl. CPC A47H 1/13; E06B 9/42; A47H 1/06

(57) ABSTRACT

A two-in-one curtain and roller blind support frame (1) includes a bonding board (10) with a board member (11), a binding groove (12) and a curtain rail (13), a pair of frames (20) combined to both sides of the board member (11) respectively, and the frames (20) are fixed to a fixed surface (2) by locking elements (22); both ends of the roller blind shaft (30) are fixed to the pair of frames (20) and combined with the roller blind (3); the plural positioning modules (40) are spaced from each other and disposed between the pair of frames (20), and each positioning module (40) includes a positioning bracket (41) and a locking component (42), and the positioning bracket (41) is secured by second locking element (43), so as to achieve the effect of simplifying the installation of two types of curtains (4).

### BACKGROUND OF THE INVENTION

### 1. Technical Field

The technical field relates to a curtain support frame, and more particularly to a two-in-one curtain and roller blind support frame.

### 2. Description of Related Art

In general, a curtain frame is mounted onto an inner wall of a window, and the curtain frame comprises a supporting and fixing structure for combining a curtain to the curtain frame.

In addition, the curtain is mainly divided into two types: a vertically up-and-down opening curtain and a sideway opening curtain applied in different ways such as roller blind, a pull curtain, etc. At present, the conventional curtain frame is equipped with a specific supporting and fixing structure for the installation of the aforementioned different types of curtains, and thus causing a cumbersome and inconvenient installation of the curtain.

In view of the aforementioned drawbacks, the discloser of this disclosure based on years of experience in the related industry to conduct extensive research and experiment, and finally provided a feasible solution to overcome the drawbacks of the prior art.

### SUMMARY OF THE INVENTION

Therefore, it is a primary objective of this disclosure to provide a two-in-one curtain and roller blind support frame to be installed to both vertically up-and-down opening and sideway opening curtains to overcome the problem of the inconvenient installation of the curtains.

To achieve the aforementioned objective, this disclosure provides a two-in-one curtain and roller blind support frame comprising a bonding board, a pair of frames, a roller blind shaft and a plurality of positioning modules. The bonding board comprises a board member and a binding groove and a curtain rail formed on the board member, and a side of the curtain is disposed on the curtain rail; a pair of frames are combined with both sides of the board member respectively, and each frame has a plurality of first coupling holes, and the frame is passed through the first coupling holes and fixed to a fixed surface by a plurality of first locking elements; both ends of the roller blind shaft are fixed to the pair of frames respectively to combine with the roller blind; the plurality of positioning modules are spaced with each other and disposed between the pair of frames, and each positioning module comprises a positioning bracket and a locking component, and the positioning bracket has a first end and a second end opposite to each other, wherein the first end has a first through hole, and the second end has at least one second through hole, and the first end is passed through the first through hole and fixed to the binding groove by the locking component, and the second end is passed through the at least one second through hole and secured to a fixed surface by the at least one second locking element.

Another objective of the present disclosure is to provide a two-in-one curtain and roller blind support frame, and its frame (including a first covering plate and a second covering plate is installed separately on both sides of the roller blind shaft to shelter the light from both left and right sides, so as to prevent the incidence of external light from a side of the curtain and improve the sheltering effect.

Compared with the prior art, the two-in-one curtain and roller blind support frame of the present disclosure has the rail formed on the bonding board, and the plurality of positioning modules installed onto the binding groove of the bonding board and fixed to the wall, and the roller blind shaft installed between a pair of frames. In addition, the roller blind shaft is provided for installing the vertically up-and-down opening roller blind, and the positioning module is provided for installing the sideway opening curtain. Therefore, the application of the two-in-one curtain and roller blind support frame can be adjusted according to the actual using requirement to improve the practicality of the present disclosure.

### BRIEF DESCRIPTION OF THE DRAWINGS

FIG. 1 is a perspective view of a two-in-one curtain and roller blind support frame of this disclosure;

FIG. 2 is an exploded view of a two-in-one curtain and roller blind support frame of this disclosure;

FIG. 3 is a schematic view of installing a two-in-one curtain and roller blind support frame of this disclosure

FIG. 4 is a partial blowup view of a two-in-one curtain and roller blind support frame of this disclosure;

FIGS. 5 to 7 are schematic views showing the use of a two-in-one curtain and roller blind support frame of this disclosure; and.

FIGS. 8 and 9 are schematic views showing another mode of use of a two-in-one curtain and roller blind support frame in accordance with this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and drawings disclosed herein are to be considered illustrative rather than restrictive.

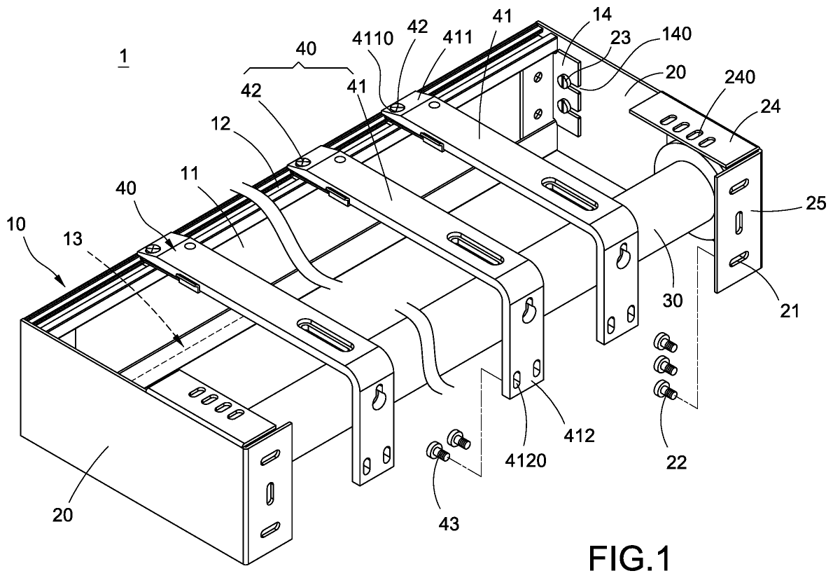

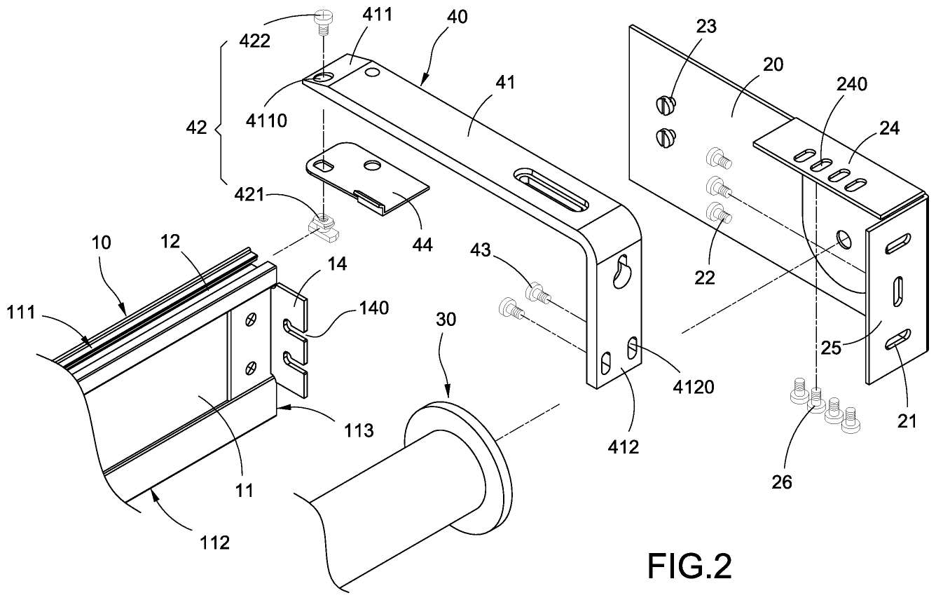

With reference to FIGS. 1 to 3 for a perspective view, an exploded view, and a schematic view of a two-in-one curtain and roller blind support frame of the present disclosure respectively, this disclosure discloses a two-in-one curtain and roller blind support frame 1 comprising: a bonding board 10, a pair of frames 20, a roller blind shaft 30 and a plurality of positioning modules 40. The pair of frames 20 are symmetrically installed to both sides of the bonding board 10, and each pair of frames 20 have an end fixed to the bonding board 10 and the other end fixed to fixed surface such as a wall or a ceiling. The roller blind shaft 30 is coupled between the pair of frames 20 for combining a vertically up-and-down opening roller blind 3 and the bonding board 10 is provided for combining a sideway opening curtain 4. In addition, the positioning modules 40 has an end fixed to the bonding board 10 and the other end fixed to a wall. The structure of the two-in-one curtain and roller blind support frame 1 of this disclosure will be described in detail below.

The bonding board 10 comprises a board member 11 and a binding groove 12 and a curtain rail 13 formed on the board member 11; and a side of the curtain is installed on the curtain rail 13. In this embodiment, the bonding board 10 is a hollow board, but this disclosure is not limited to such arrangement only. In addition, the board member 11 has a top surface 111, a bottom surface 112 and two opposite sides 113. The binding groove 12 is formed on the top surface 111; and the curtain rail 13 is formed on the bottom surface 112. In an embodiment of the present disclosure, a bent plate 14 is coupled to a side 113 of the board member 11 separately.

The pair of frames 20 are combined with both sides of the bonding board 10 respectively and disposed on the bent plate 14 of the bonding board 10 separately. Further, each of the frames 20 has a plurality of first coupling holes 21, and the frame 20 is passed through the first coupling holes 21 and fixed to a fixed surface by the plurality of first locking elements 22.

Specifically, the bent plate 14 has at least one fixing hole 140. In a preferred embodiment, the fixing hole 140 is J-shaped. In addition, a side of the frame 20 facing the bent plate 14 has at least one positioning bump 23, and the frame 20 is positioned in the fixing hole 140 and fixed to the bent plate 14 by the positioning bump 23.

In addition, the roller blind shaft 30 is installed between the pair of frames 20, and both ends of the roller blind shaft 30 are fixed to the pair of frames 20 respectively to combine with a roller blind.

It is noteworthy that each of the frames 20 is bent and extended to form a first covering plate 24 disposed on an upper side of the roller blind shaft 30 and a second covering plate 25 disposed on an outer side of the roller blind shaft 30. In this embodiment, the first coupling holes 21 are formed on the second covering plate 25.

Specifically, each of the first covering plates 24 and each of the second covering plates 25 are perpendicular to each other and disposed on an outer side of the bonding board 10 away from the frame 20. It is noteworthy that the frames 20 (including the first covering plate 24 and the second covering plate 25 are mounted onto two sides of the roller blind shaft 30 respectively to shelter the light coming from both left and right sides to prevent the incidence of external light from a side of the roller blind shaft 30 and improve the shading effect.

In this embodiment, the first covering plate 24 has a plurality of second coupling holes 240; and the second coupling holes 240 are provided for the plurality of screws 26 to pass through and fix onto a ceiling, so as to improve the positioning effect and stability.

In addition, the positioning modules 40 are spaced from each other and disposed between the pair of frames 20. Each of the positioning modules 40 comprises a positioning bracket 41 and a locking component 42. The positioning bracket 41 has a first end 411 and a second end 412 opposite to each other, and the first end 411 has a first through hole 4110, and the second end 412 has at least one second through hole 4120. The first end 411 is passed through by the locking component 42 and fixed to the binding groove 12 of the bonding board 10 by the first through hole 4110, and the second end 412 is passed through the second through hole 4120 and secured to a fixed surface 2 by a second locking element 43. In a preferred embodiment, each of the positioning brackets 41 is L-shaped.

In this embodiment, each of the positioning modules 40 further comprises a support plate 44 fixed to a bottom surface (112) of the positioning bracket 41 to improve the support of the positioning bracket 41.

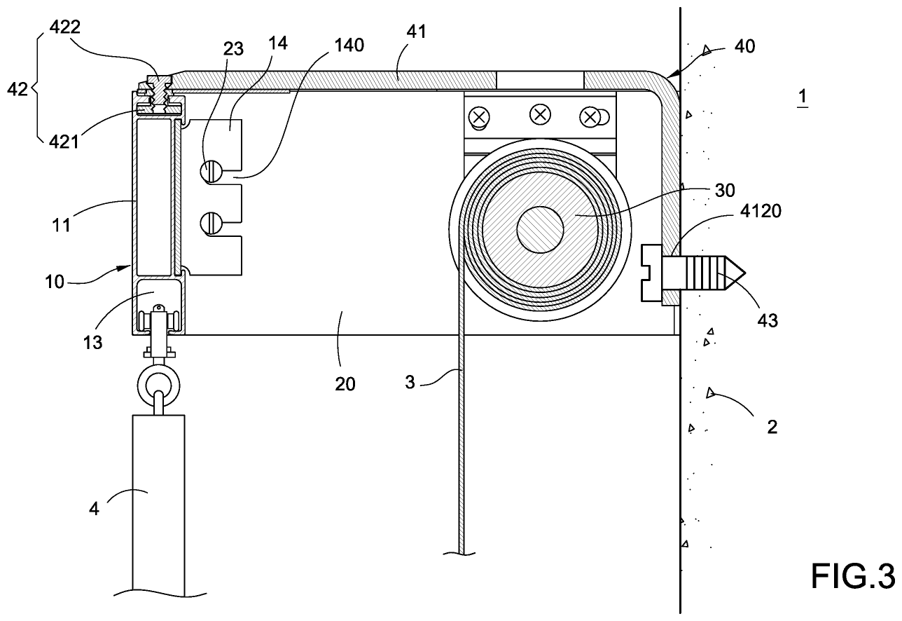

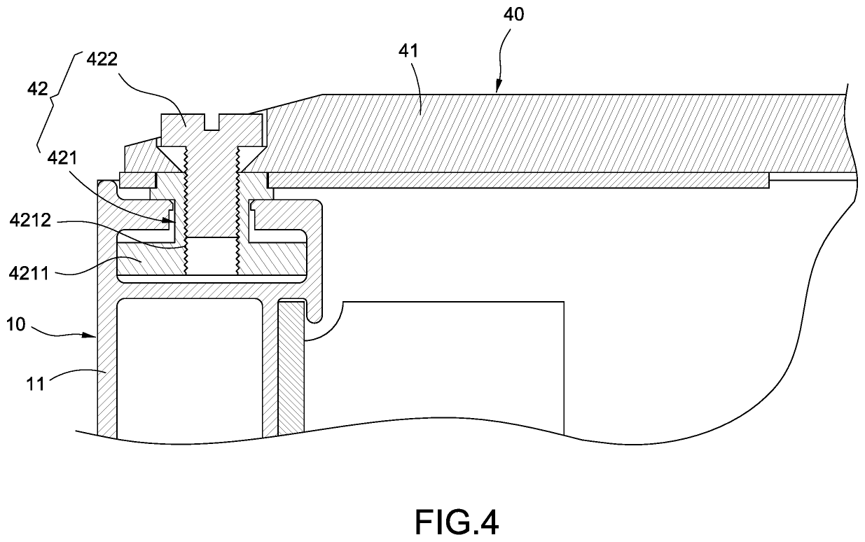

With reference to FIGS. 3 and 4 for a schematic installation view and a partial blowup view of a two-in-one curtain and roller blind support frame of the present disclosure respectively, the two-in-one curtain and roller blind support frame 1 is mounted onto a fixed surface 2 and combined with a roller blind 3 and/or a curtain 4.

In FIG. 3, the board member 11 is fixed onto the fixed surface 2; and the roller blind 3 is installed to the roller blind shaft 30, and the curtain 4 is hung onto the curtain rail 13 of the positioning bracket 41.

In this embodiment as shown in FIG. 4, the binding groove 12 of the bonding board 10 is a T-shaped groove; and the locking component 42 comprises a T-shaped screw seat 421 and a stud 422. The T-shaped screw seat 421 has a stop plate 4211 passing into the T-shaped groove and protruding from a screw hole 4212 of the T-shaped groove. The positioning bracket 41 is passed through the positioning bracket 41 and the screw hole 4212 and combined with the bonding board 10 by the stud 422.

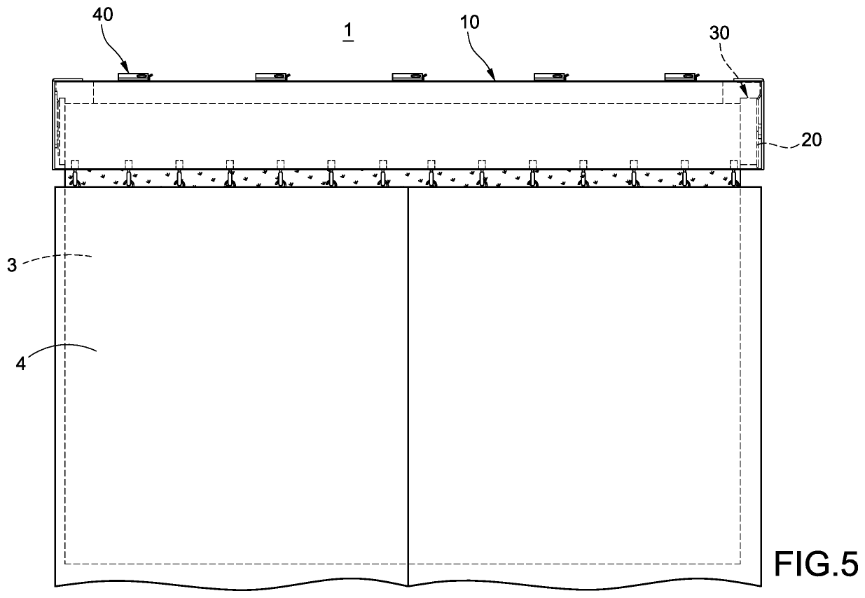

With reference to FIGS. 5 to 7 for the schematic views of using a two-in-one curtain and roller blind support frame of the present disclosure, the two-in-one curtain and roller blind support frame 1 is combined with a roller blind 3 and a curtain 4. In FIG. 5, the roller blind 3 is situated at a vertically drooping status to shelter a window while the curtain 4 is situated at a sideway closed status to shelter the window.

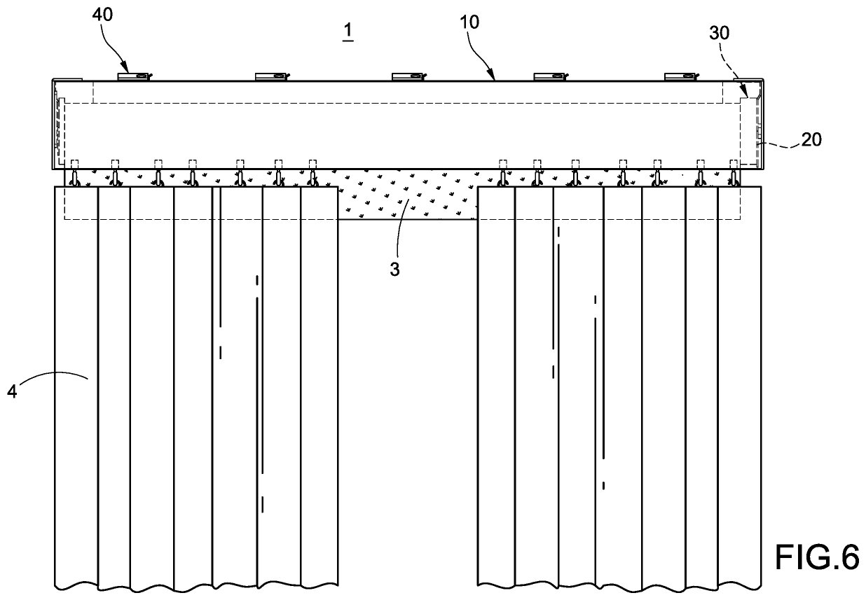

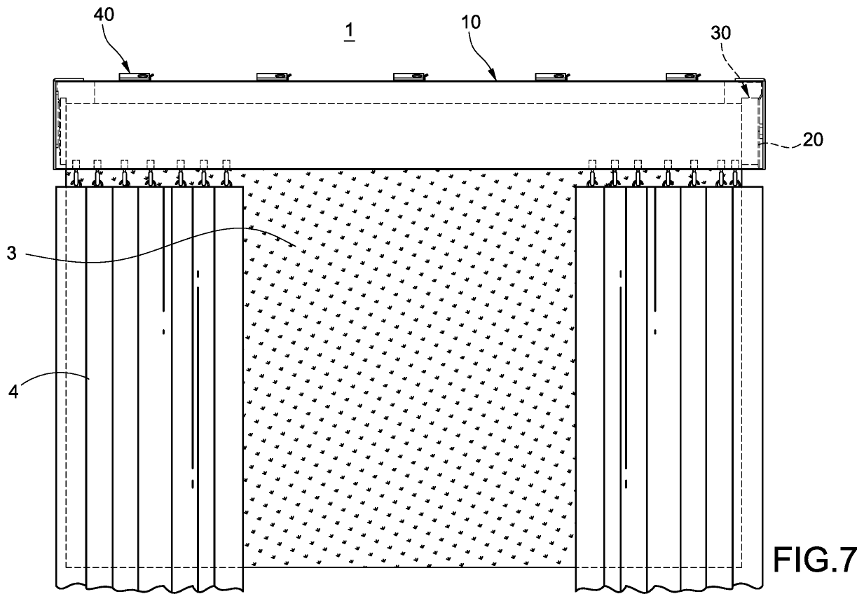

In FIG. 6, the roller blind 3 is situated at an upwardly rolled status, so that just the curtain 4 shelters the window only. In FIG. 7, the curtain 4 is opened sideway, so that just the roller blind 3 shelters the window only.

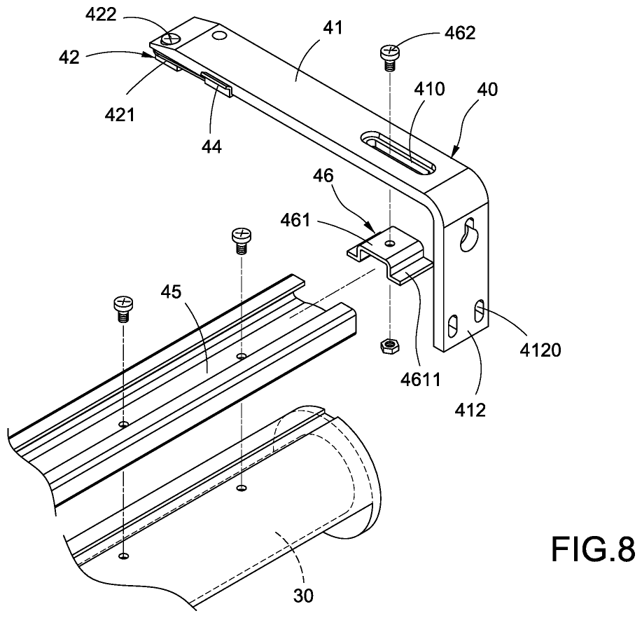

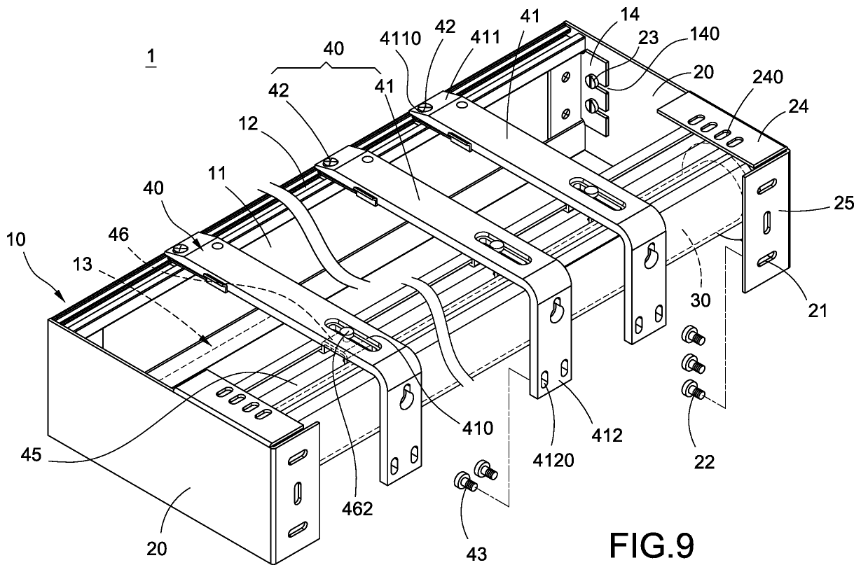

With reference to FIGS. 8 and 9 for the schematic views of using a two-in-one curtain and roller blind support frame in accordance with another implementation mode of the present disclosure, the positioning modules 40 of the two-in-one curtain and roller blind support frame 1 further comprises an auxiliary support 45 and a plurality of auxiliary locking components 46. When the length of the roller blind shaft 30 is relatively long, the stability of the roller blind shaft 30 can be improved by the auxiliary support of the auxiliary support 45 and the auxiliary locking components 46. The roller blind shaft 30 is fixed onto the auxiliary support 45 and combined with the positioning brackets 41 by the auxiliary locking components 46.

Specifically, the positioning brackets 41 have an auxiliary through hole 410; and each of the auxiliary locking components 46 comprises an auxiliary seat 461 and an auxiliary screw 462, and the auxiliary seat 461 is mounted onto the auxiliary support 45, and the positioning bracket 41 and the auxiliary support 45 are passed through the auxiliary through hole 410 and the auxiliary seat 461 for a connection by the auxiliary screw 462. In more detail, the auxiliary support 45 is a U-shaped rail, and the auxiliary seat 461 has a pair of flaps 4611, and the auxiliary seat 461 is passed into the auxiliary support 45 by the pair of flaps 4611.

In summation, the application of the two-in-one curtain and roller blind support frame 1 of the present disclosure may be adjusted according to the actual using requirement to improve the practicality of the present disclosure.

In summation of the description above, this disclosure can achieve the expected purpose of use and overcome the drawbacks of the prior art. In addition, this disclosure complies with the patent application requirements, and is thus duly filed for patent application. While this disclosure has been described by means of specific embodiments, numerous modifications and variations could be made thereto by those skilled in the art without departing from the scope and spirit of this disclosure set forth in the claims.

What is claimed is:

1. A two-in-one curtain and roller blind support frame (1), comprising:
a bonding board (10), including a board member (11) and a binding groove (12) and a curtain rail (13) formed on the board member (11), and a side of the curtain (4) being disposed on the curtain rail (13);
a pair of frames (20), combined with both sides of the board member (11) respectively, and each of the frames (20) having a plurality of first coupling holes (21), and passing through the first coupling holes (21) and being fixed to a fixed surface (2) through the frame by a plurality of first locking elements (22);
a roller blind shaft (30), with both ends fixed to the pair of frames (20) respectively to combined with the roller blind (3); and
a plurality of positioning modules (40), spaced with each other and disposed between the pair of frames (20), each of the positioning modules (40) comprising a positioning bracket (41) and a locking component (42), and the positioning bracket (41) having a first end (411) and a second end (412) opposite to each other, and the first end (411) having a first through hole (4110), and the second end (412) having at least one second through hole (4120), and the first end (411) being passed through the first through hole (4110) and fixed to the binding groove (12) by the locking component (4120), and the second end (412) being passed through the at least one second through hole (4120) and secured to the fixed surface (2) by at least one second locking element (43).

2. The two-in-one curtain and roller blind support frame as claimed in claim 1, wherein the board member (11) has a top surface (111), a bottom surface (112) and two opposite sides (113), and the binding groove (12) is formed on the top surface (111), and the curtain rail (13) is formed on the bottom surface (112), and a bent plate (14) is formed on each of the sides, and the pair of frames (20) are combined with the bent plates (14) respectively.

3. The two-in-one curtain and roller blind support frame as claimed in claim 2, wherein the bent plate (14) has at least one fixing hole (140), and a side of the frame (20) facing the bent plate (14) has at least one positioning bump (23), and the frame (20) is positioned in the fixing hole (140) and fixed to the bent plate (14) by the positioning bump (23).

4. The two-in-one curtain and roller blind support frame as claimed in claim 3, wherein the fixing hole (140) is J-shaped.

5. The two-in-one curtain and roller blind support frame as claimed in claim 2, wherein the binding groove (12) is a T-shaped groove, and the locking component comprises a T-shaped screw seat (421) and a stud (422), and the T-shaped screw seat (421) has a stop plate (4211) passing into the T-shaped groove and protruding from a screw hole (4212) of the T-shaped groove, and the positioning bracket (41) is passed through the positioning bracket (41) and the screw hole (4212) and combined with the bonding board by the stud (422).

6. The two-in-one curtain and roller blind support frame as claimed in claim 1, wherein each of the positioning modules (40) further comprises a support plate (44) fixed to a bottom surface (112) of the positioning bracket (41).

7. The two-in-one curtain and roller blind support frame as claimed in claim 1, wherein each of the frames (20) has a bent and extended first covering plate (24) disposed on an upper side of the roller blind shaft (30) and a second covering plate (25) disposed on an outer side of the roller blind shaft (30).

8. The two-in-one curtain and roller blind support frame as claimed in claim 7, wherein each of the first covering plates and each of the second covering plates (25) are perpendicular to each other and disposed on a side of the frame facing the fixed surface.

9. The two-in-one curtain and roller blind support frame as claimed in claim 7, wherein the first covering plate has a plurality of second coupling holes (240) for passing and installing a plurality of screws (26).

10. The two-in-one curtain and roller blind support frame as claimed in claim 1, wherein each of the frames (20) is L-shaped.

11. The two-in-one curtain and roller blind support frame as claimed in claim 1, wherein the positioning module (40) further comprises an auxiliary support (45) and a plurality of auxiliary locking components (46), and the roller blind shaft (30) is fixed to the auxiliary support (45) and combined with the positioning brackets (41) by the auxiliary locking components (46).

12. The two-in-one curtain and roller blind support frame as claimed in claim 11, wherein the positioning bracket (41) has an auxiliary through hole (410), and each of the auxiliary locking components (46) comprises an auxiliary seat (461) and an auxiliary screw (462), and the auxiliary seat (461) is installed on the auxiliary support (45), and the positioning bracket (41) and the auxiliary support (45) are passed into the auxiliary through hole (410) and the auxiliary seat (461) for a connection by the auxiliary screw (462).

13. The two-in-one curtain and roller blind support frame as claimed in claim 12, wherein the auxiliary support (45) is a U-shaped rail, and the auxiliary seat (461) has a pair of flaps (4611), and the auxiliary seat (461) is passed and installed into the auxiliary support (45) by the pair of flaps (4611).
